(19) United States
(12) Patent Application Publication
(10) Pub. No.: US 2008/0225891 A1
(43) Pub. Date: Sep. 18, 2008

(54) FLEXIBLE PDU SIZES FOR UNACKNOWLEDGED MODE RADIO LINK CONTROL

(75) Inventors: Christopher R. Cave, Verdun (CA); Diana Pani, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/048,342

(22) Filed: Mar. 14, 2008

Related U.S. Application Data
(60) Provisional application No. 60/894,937, filed on Mar. 15, 2007.

(51) Int. Cl. H04J 3/22

(52) U.S. Cl. 370/472

(57) ABSTRACT

A method for determining an unacknowledged mode radio link control protocol data unit (PDU) size in a wireless transmit receive unit (WTRU) includes the WTRU setting a maximum PDU size, and the WTRU setting a maximum total data transferred size. The PDU size is flexible up to the maximum PDU size.

### CROSS REFERENCE TO RELATED APPLICATIONS

This application claims the benefit of U.S. provisional application Nos. 60/894,937 filed Mar. 15, 2007 which is incorporated by reference as if fully set forth

### FIELD OF INVENTION

The present invention is related to wireless communications.

### BACKGROUND

A goal of the Third Generation Partnership Project (3GPP) Long Term Evolution (LTE) program is to develop new technology, new architecture and new methods for settings and configurations in wireless communication systems in order to improve spectral efficiency, reduce latency and better utilize the radio resource to bring faster user experiences and richer applications and services to users with lower costs.

The Radio Link Control Protocol (RLC) is a Level 2 (L2) protocol within 3GPP Universal Mobile Telephone Service (UMTS) systems that provides segmentation, retransmission, and flow control services for control and user data. The RLC can be configured to operate in Transparent Mode (TM), Unacknowledged Mode (UM) and Acknowledged Mode (AM). When configured in UM, there is no retransmission mechanism. Delivery of data is not guaranteed. UM does offer the following services and functions: segmentation and reassembly, concatenation, padding, transfer of user data, ciphering, sequence number check, service data unit (SDU) discard, out of sequence SDU delivery, and duplicate avoidance and reordering. The UM RLC is typically used for the transfer of time sensitive services such as Voice over Internet Protocol (VoIP) and multiple broadcast/multicast services (MBMS).

An AM RLC supports flexible protocol data unit (PDU) sizes. The AM RLC is configured by higher layers to operate with a maximum, rather than a single, PDU size. Flexible PDU sizes may reduce the possibility of the RLC stalling at high data rates, where the RLC has been shown to be a throughput bottleneck.

The AM RLC is configured to operate with a maximum PDU size rather than a fixed PDU size, and therefore should only segment SDUs that are larger than the maximum PDU size. RLC PDUs are segmented and/or concatenated at a medium access control (MAC) layer in a Node B where an ideal transport block size is selected based on instantaneous channel conditions.

In existing UM operation, the RLC is configured by higher layers to create and deliver PDUs according to a set of fixed sizes. For each transmission time interval (TTI), the MAC layer decides which UM RLC PDU size shall be used and how many UM RLC PDUs shall be transmitted. The MAC layer selects the UM RLC PDU size from a finite list of PDU sizes, configured by higher layers.

In order to deliver PDUs of a fixed size, the UM RLC concatenates the last segment of an RLC SDU with the first segment of the next RLC SDU in order to fill the data field completely. Alternatively, the RLC adds padding bits in order to fill the data field.

The transfer of variable size RLC PDUs in UM is not supported. Flexible or variable PDU sizes for UM RLC would be beneficial for VoIP applications since VoIP packets are compressed at the packet data protocol control (PDPC) layer using the Robust Header Compressions (ROHC) algorithm, which generates different packet sizes from one TTI to another, depending on the compressor state. Flexible UM RLC PDUs would eliminate the overhead caused by padding.

### SUMMARY

A method and apparatus is disclosed to operate a UM RLC protocol with variable PDU sizes. This may include mechanisms to support flexible or variable PDU sizes. The PDUs may be measured in bits or octets. Parameters and primitives may be used by the RLC to communicate with other layers. The parameters and primitives may include information regarding PDU sizes, and may include PDU measurements in bytes or octets.

### BRIEF DESCRIPTION OF THE DRAWING

A more detailed understanding may be had from the following description, given by way of example and to be understood in conjunction with the accompanying drawing wherein:

FIG. 1 shows an example of a wireless communication system in accordance with one embodiment;

FIG. 2 shows a functional block diagram of a WTRU and a Node B of FIG. 1;

FIG. 3 is a functional block diagram of UM signal transmission in accordance with one embodiment;

FIG. 4 shows a flow diagram for a transmission process of an RLC message in accordance with one embodiment; and

FIG. 5 shows a flow diagram for a reception process of a RLC message in accordance with one embodiment.

### DETAILED DESCRIPTION

When referred to hereafter, the term “wireless transmit/receive unit (WTRU)” includes, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the term “base station” includes, but is not limited to, a Node B, a site controller, an access point (AP), or any other type of interfacing device capable of operating in a wireless environment.

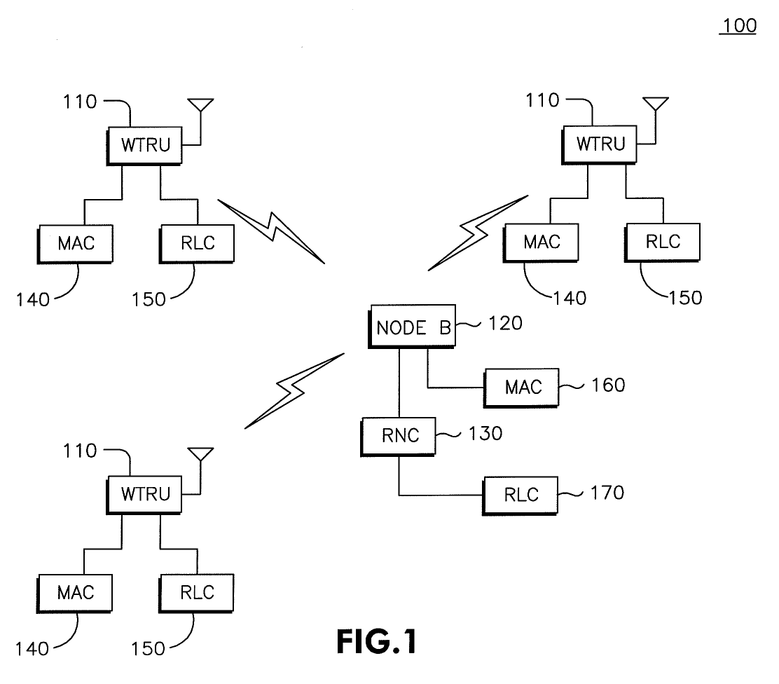

FIG. 1 shows a wireless communication system 100 including a plurality of WTRUs 110 a Node B 120 and a Radio Network Controller (RNC) 130. As shown in FIG. 1, the WTRUs 110 and the RNC 130 are in communication with the Node B 120. Although three WTRUs 110 and one Node B 120 are shown in FIG. 1, it should be noted that any combination of wireless and wired devices may be included in the wireless communication system 100. The WTRUs 110 each include a MAC 140 and an RLC 150. The Node B 120 also includes a MAC 160 and the RNC 130 includes an RLC 170.

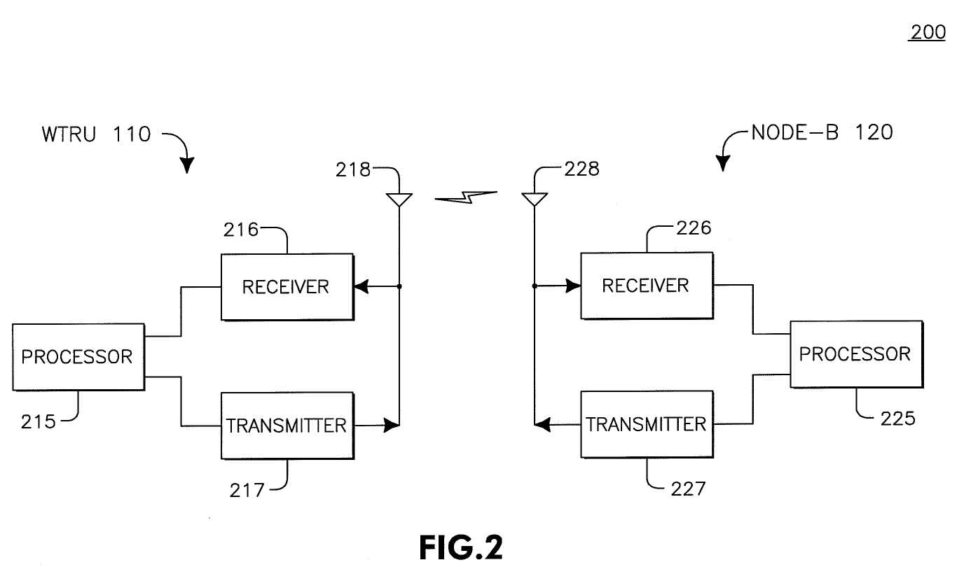

FIG. 2 is a functional block diagram 200 of the WTRU 110 and the Node B 120 of the wireless communication system 100 of FIG. 1. The WTRU 110 is in communication with the Node B 120 which includes a MAC 160. The Node B 120 is in communication with an RNC 130 which includes a RLC 170. The WTRU 110, Node B 120 and RNC 130 are configured to function in AM, UM or TM.

In addition to the components that may be found in a typical WTRU, the WTRU 110 includes a processor 215, a receiver 216, a transmitter 217, and an antenna 218. The processor 215, receiver 216 and transmitter 217 are configured to operate in UM, AM and TM. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical Node B, the Node B 120 includes a processor 225, a receiver 226, a transmitter 227, and an antenna 228. The processor 225, the receiver 226 and the transmitter 227 are configured to function in AM, UM and TM. The receiver 226 and the transmitter 227 are in communication with the processor 225. The antenna 228 is in communication with both the receiver 226 and the transmitter 227 to facilitate the transmission and reception of wireless data.

A UM data transfer procedure may be used for transferring data between two RLC peer entities that are operating in UM. For each TTI, the MAC layer may determine a maximum amount of data that the UM RLC can deliver to lower layers for information transfer service. At least one of the following two parameters can be determined: 1) a maximum UM RLC PDU size that can be delivered; and 2) a maximum total of data transferred, measured in bits or in octets. The sum of all UM RLC PDU should be less than a maximum total of data transferred. Alternatively, a maximum UM RLC PDU size and a maximum number of PDUs to deliver may be defined. Alternatively, the parameters can be configured by higher layers (i.e., the RRC layer) upon establishment or reconfiguration of the radio bearer. The parameters can represent the amount of data that can be delivered during a predetermined time interval, such as a TTI or another indication, for example.

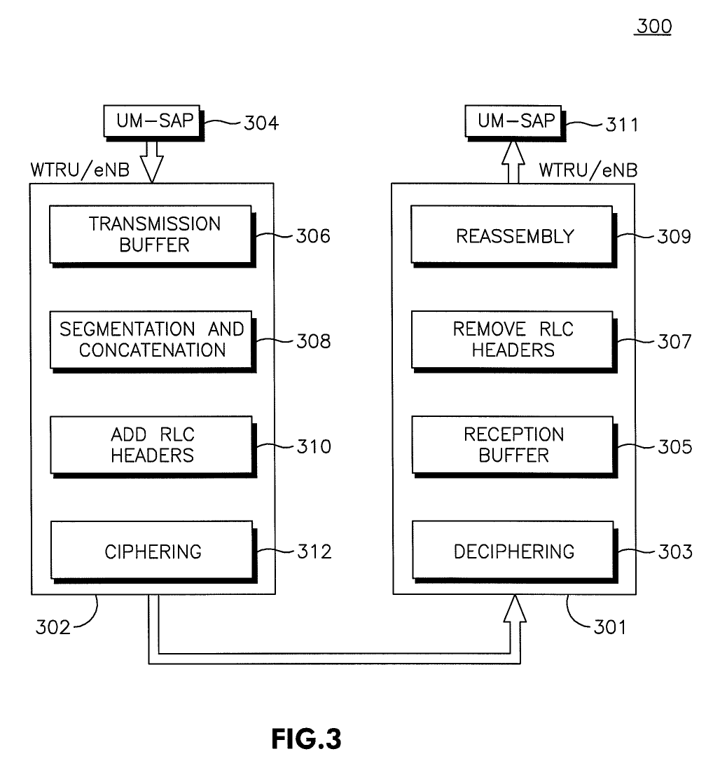

FIG. 3 is a functional block diagram of UM signal transmission 300 in accordance with one embodiment. A transmit entity 302 can be a WTRU (110 of FIG. 1) or a Node B (112 of FIG. 2). The SDUs for transmission are passed through the UM-service access point (SAP) to a transmission buffer 306. Each SDU is then sent to a segmentation and concatenation unit 308 where the SDUs are processed into RLC PDUs. If fixed size PDUs are used, the SDUs are reconfigured to match the fixed PDU size, which may require segmentation, concatenation, and the addition of padding bits.

However, if flexible PDU sizes are supported, under certain circumstances, the SDU is segmented if it is larger than a maximum RLC PDU size. The maximum size may be configured by upper layers, such as the radio resource control (RRC), for example. Concatenation may be performed up to the maximum RLC PDU size.

Alternatively, an upper layer such as the RRC, for example, sets an absolute maximum PDU size. For each TTI, the MAC layer sets a maximum PDU size that does not exceed the upper layer absolute maximum. The MAC may determine PDU size based on radio conditions that affect the amount of data that may be sent over the air interface and scheduling of data from various users, for example. Primitives passed between the RLC and MAC may be used to communicate the limits.

An RLC header unit 310 adds an RLC header to each PDU. If fixed PDU sizes are used, the header may include a length indicator. However, if flexible PDU sizes are allowed, the length indicator may be configured by an upper layer. Once the RLC header is added, the PDU may be ciphered by a ciphering unit 312 prior to transmission.

The receiver 301 may be a WTRU (110 of FIG. 1) or a Node B (112 of FIG. 2) or any other compatible wireless device. At the receiver 301 the ciphered PDU is deciphered in a deciphering unit 303. The PDUs are then placed in a reception buffer 305 until a complete RLC SDU is received. The RLC header is removed at a header removal unit 307, and the reassembly unit 309 reassembles the SDUs that are then sent to the upper layers through the RLC-SAP 311.

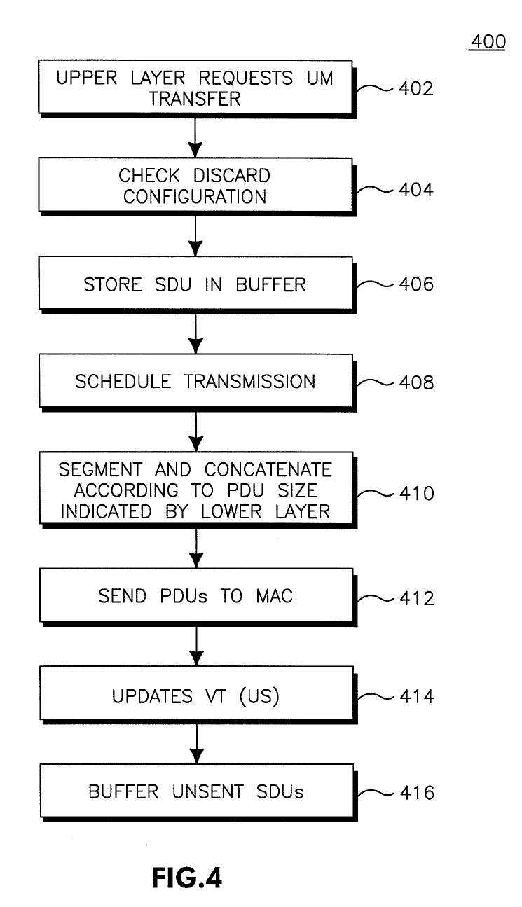

FIG. 4 shows a flow diagram for a transmission process for an RLC message. At step 402 an upper layer requests an UM transfer. The transmitter, at step 404, checks if the SDU discard configuration is set. If yes, SDU discard will be based on a timer. If not, SDUs will be discarded if the buffer is full. At step 406 the SDUs are stored in a transmission buffer. At step 408, the MAC schedules transmission and, at step 410, the SDUs are segmented and concatenated to a PDU size indicated by the lower layer, if the PDU size is fixed. If the PDU size is flexible, the SDUs are processed such that each PDU does not exceed a maximum size. At step 412 the PDUs are sent to the MAC layer and, at step 414, the state variable VT(US) is updated. Any remaining SDUs are buffered at step 416.

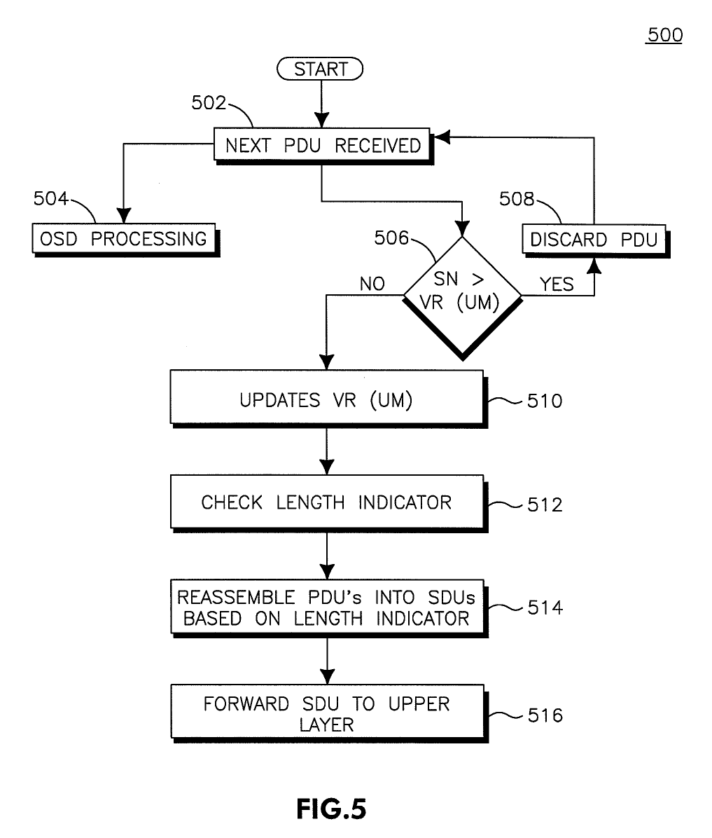

FIG. 5 shows a flow diagram for a reception process 500 for a RLC message. The receiving entity, at step 502, receives a PDU. At step 504, out-of-sequence processing is performed if out-of sequence processing is configured. If out of sequence processing is not configured, at step 506, the receiving entity checks the sequence number of the received PDU against the VR(UM) state variable. If the sequence number is larger than the state variable, at step 508, the PDU is discarded and the next PDU is received at step 502. Otherwise, at step 510 the VR(UM) state variable is updated. The length indicator is checked at step 512. Based on the value of the length indicator, at step 514 the PDUs are reassembled into SDUs. At step 516, the SDUs are forwarded to the upper layers.

When using flexible PDU sizes, sequence numbering may be performed on a per byte basis. The sequence number that is included in the RLC header may correspond to the sequence number of the first byte that is included in the payload. For fixed PDU sizes, sequence numbering is typically performed on a per PDU basis. The RLC protocol includes a number of parameters that are passed between RLC entities. These parameters include, but are not limited to: Configured_Rx_Window_Size, Configured_Tx_Window_Size, OSD_Window_Size, and DAR_Window_Size. These parameters can be configured by higher layers (i.e., the RRC layer) upon establishment or reconfiguration of the radio bearer and may represent the amount of data that can be delivered during a TTI, the amount of data that can be delivered during any other pre-determined time interval, or the amount of data that can be delivered until the next indication.

Configured_Rx_Window_Size indicates the reception window size. This is a maximum amount of data that can be received in any single TTI, and is variable from TTI to TTI. Similarly, the Configured_Tx_Window_size parameter indicates a transmission window size, OSD_Window_Size indicates a size of the out-of-sequence SDU delivery storage window and the DAR_Window_Size indicates a size of the duplicate avoidance and reordering receive window. For fixed PDU sizes, these parameters are indicated in terms of number of PDUs. However, if flexible PDU sizes are used, these parameters may be indicated in number of bytes.

Primitives are used as a basic or fundamental unit of instruction between a MAC entity and an RLC entity. MAC_DATA_XXX and MAC_STATUS_XXX are two primitives used in the RLC protocol, wherein XXX may be a Request, an Indication or a Response.

The MAC-DATA-Indication primitive is used by the receiving MAC to indicate the reception of a UM RLC PDU. The primitive should include the PDU size, either measured in bits or in octets, of each UM RLC PDU that has been received. Alternatively, the total size or the sum of the sizes of individual UM RLC PDUs received can be indicated, measured in bits or octets. Alternatively, the size of the received transport block can be indicated.

The MAC-STATUS-Indication primitive, which indicates to the UM RLC on the transmitting side for each logical channel the rate at which it may transfer data to MAC, should include the maximum number of bits or octets that can be delivered to the MAC for information transfer service. The maximum size (measured in bits or octets) parameter corresponds to the sum of all UM RLC PDUs that are delivered to the MAC, preferably per TTI. Alternatively, the maximum size parameter could be interpreted as the maximum amount of data that the UM RLC can deliver to the MAC over any other fixed period of time. Alternatively, the maximum size parameter can be interpreted as the amount of data that the UM RLC can deliver until the next time a maximum size is indicated using the MAC-STATUS-Indication primitive.

The MAC-DATA-Request primitive, which is used to request that an upper layer PDU be sent using the procedures for the information transfer service, may include the size, either measured in bits or in octets, of each RLC PDU that is delivered to the MAC layer.

Although the features and are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for determining an unacknowledged mode (UM) radio link control (RLC) protocol data unit (PDU) size in a wireless transmit receive unit (WTRU), the method comprising setting at least one of:
a maximum PDU size;
a maximum total data transferred size, wherein the PDU size is flexible up to the maximum PDU size; and
a maximum number of PDUs that can be delivered to a lower layer in a given time interval

2. The method as in claim 1 further comprising performing a sequence numbering operation on a per byte basis.

3. The method as in claim 1 wherein an RLC header sequence number corresponds to a sequence number in a first byte of a payload.

4. The method as in claim 1 further comprising measuring the PDU size in octets.

5. The method as in claim 1 further comprising measuring the PDU size in bits.

6. The method as in claim 1 wherein a sum of PDUs is less than the maximum total data transferred size.

7. The method as in claim 1 wherein the maximum total data transferred size is measured in bits.

8. The method as in claim 1, wherein the maximum total data transferred size is measured in octets.

9. The method as in claim 1 further comprising a higher layer setting at least one of:
the maximum PDU size and
the maximum total data transferred size.

10. The method as in claim 9 further comprising the higher layer setting the at least one of the maximum PDU size and the maximum total data transferred size upon radio bearer establishment.

11. The method as in claim 9 wherein the higher layer is a radio resource control (RRC) layer.

12. The method as in claim 1 further comprising measuring the maximum PDU size and the maximum total data transferred size for a predetermined time interval.

13. The method as in claim 12 wherein the predetermined time interval is a transmission time interval (TTI).

14. The method as in claim 12 wherein the predetermined time interval is an indication.

15. The method as in claim 1 further comprising the MAC and the RLC communicating via a Configured Rx_Window_Size parameter, a Configured_Tx_Window_Size parameter, an OSD_Window_Size parameter and a DAR_Window_Size parameter, wherein the parameters are indicated in terms of a number of bytes.

16. The method as in claim 1 further comprising the MAC and the RLC communicating via a MAC-DATA-Indication primitive, a. MAC-STATUS-Indication primitive, a MAC-DATA-Request primitive, wherein the primitives comprise a PDU size expressed as a number of bits.

17. The method as in claim 1 further comprising the MAC and the RLC communicating via a MAC-DATA-Indication primitive, a. MAC-STATUS-Indication primitive, a MAC-DATA-Request primitive, wherein the primitives comprise a PDU size expressed as a number of octets.

18. A method of transmitting a message from a first unacknowledged mode (UM) Radio Link Control (RLC) entity to a second UM RLC entity, the method comprising:
forwarding a service data unit (SDU) to an RLC transmission buffer;
determining an SDU size;
comparing the SDU size with a maximum PDU size;
processing the SDU based on the comparison to create a PDU; and
forwarding the PDU for transmission.

19. The method as in claim 18 further comprising a higher layer setting the maximum PDU size.

20. The method as in claim 18 wherein the maximum PDU size is determined in units of bits

21. The method as in claim 18 wherein the maximum PDU size is determined in units of octets.

22. The method as in claim 18 further comprising:
determining a total data transferred size;
determining a maximum total data transferred size;
comparing the total data transferred size to the maximum total data transferred size; and
adjusting the transmission process based on the comparison of total data transferred size to maximum total data transferred size.

23. A wireless transmit receive unit (WTRU) comprising a radio link control (RLC) and a medium access control (MAC) wherein the RLC is configured to:
receive a service data unit (SDU) from a higher layer;
buffer the SDU;
determine a SDU size;
compare the SDU size with a maximum PDU size;
process the SDU based on the comparison to create a PDU; and
forward the PDU for transmission.

24. The WTRU as in claim 23 wherein the WTRU further comprises a higher layer and the higher layer is configured to determine the maximum PDU size.

25. The WTRU as in claim 23 wherein the WTRU determines the maximum PDU size in units of bytes.

26. The WTRU as in claim 23 wherein the WTRU determines the maximum PDU size in units of octets.

27. The WTRU as in claim 23 wherein the WTRU is further configured to:
determine a total data transferred size;
determine a maximum total data transferred size;
compare the total data transferred size to the maximum total data transferred size; and
adjust the transmission process based on the comparison.

28. A method for determining an unacknowledged mode (UM) radio link control (RLC) protocol data unit (PDU) size in a wireless transmit receive unit (WTRU), the method comprising:
setting an absolute maximum PDU size at a first function;
determining a temporary maximum PDU size at a second function; and
processing a service data unit (SDU) into a PDU based on the temporary maximum PDU size; wherein the temporary maximum PDU size is smaller than the absolute maximum PDU size.

29. The method as in claim 28 further comprising a medium access control (MAC) determining the temporary maximum PDU size on a per transmission time interval (TTI) basis.

30. The method as in claim 28 further comprising a Radio Resource Control (RRC) determining the absolute maximum PDU size.

31. The method as in claim 30 further comprising determining the temporary maximum PDU size based on a data capacity of an air interface.

32. The method as in claim 31 further comprising determining the data capacity of the air interface based on radio conditions and scheduling of user data.

33. The method as in claim 28 further comprising a medium access control (MAC) and a radio link control (RLC) communicating the absolute maximum PDU size and the temporary maximum PDU size via primitives.

34. A wireless transmit receive unit (WTRU) operating in unacknowledged mode (UM), wherein the WTRU comprises:
a first function configured to set an absolute maximum protocol data unit (PDU) size;
a second function configured to determine a temporary maximum PDU size; and
a processor configured to process a service data unit (SDU) into a PDU based on the temporary maximum PDU size; wherein the temporary maximum PDU size is smaller than the absolute maximum PDU size.

35. The WTRU as in claim 34 wherein the first function comprises a medium access control (MAC) configured to determine the temporary maximum PDU size on a per transmission time interval (TTI) basis.

36. The WTRU as in claim 34 wherein the second function comprises a Radio Resource Control (RRC) configured to determine the absolute maximum PDU size.

37. The WTRU as in claim 35 wherein the MAC is configured to determine the temporary maximum PDU size based on a data capacity of an air interface.

38. The WTRU as in claim 37 wherein the MAC is further configured to determine the data capacity of the air interface based on radio conditions and scheduling of user data.
